(19) United States
(12) Patent Application Publication
(10) Pub. No.: US 2026/0141495 A1
(43) Pub. Date: May 21, 2026

(54) INFORMATION PROCESSING APPARATUS FOR CONTROLLING IMAGE DISPLAY, INFORMATION PROCESSING SYSTEM, STORAGE MEDIUM, AND INFORMATION PROCESSING METHOD

(71) Applicant: CANON KABUSHIKI KAISHA, Tokyo (JP)

(72) Inventor: WAKAKI HATTORI, Tokyo (JP)

(21) Appl. No.: 19/386,048

(22) Filed: Nov. 11, 2025

(30) Foreign Application Priority Data
Nov. 20, 2024 (JP) 2024-202202

(51) Int. Cl. G06T 5/73; G06T 7/00; G11B 27/031

(52) U.S. Cl. CPC G06T 5/73; G06T 7/0002; G11B 27/031; G06T 2207/10016; G06T 2207/20201; G06T 2207/30168

(57) ABSTRACT

An information processing apparatus to, perform blur correction processing on a first frame image included in a plurality of frame images based on an amount of subject blur in the first frame image caused by movement of an imaging apparatus for capturing a moving image content, and perform display control processing for control to distinguishably display a first section and a second section in the timeline area on the screen, wherein the first section being a section of a frame image having the field of view that satisfies a predetermined condition, and the second section being a section of a frame image having the field of view that does not satisfy the predetermined condition.

### BACKGROUND

### Field of the Technology

The present disclosure relates to an information processing apparatus for controlling image display, and an information processing system, a storage medium, and an information processing method.

### Description of the Related Art

As a moving image for virtual reality (VR), VR180 moving images are used in which two different images with a 180-degree field of view are displayed side by side. When a VR180 moving image is viewed using a head-mounted display, blur in the moving image can cause VR sickness. For this reason, blur correction needs to be applied to the moving image during video editing. In typical moving images, when blur correction causes invalid regions, i.e., regions where no moving images are captured, processing, such as cropping some parts of the image, is applied so that those invalid regions do not appear in the moving images.

Japanese Patent Laid-Open No. 2020-123863 describes a technique of displaying a blur correction frame indicating an image region to be cropped for blur correction based on the maximum amount of blur in a moving image.

Since VR180 moving images require a 180-degree field of view, regions in the images that can be cropped are limited. Thus, invalid regions, i.e., regions where no actual images are captured, may occur within the 180-degree field of view. The amount of blur correction varies from frame to frame, and thus, sizes of the invalid regions also differ for each frame. Consequently, valid regions (or effective fields of view), i.e., regions where actual images are captured within the 180-degree field of view, also vary. When such moving images are viewed using a head-mounted display, the effective field of view continues changing, and some frames may display invalid regions during playback, which degrades the viewing experience.

### SUMMARY

The present disclosure has been made in view of the above-described issue, and is directed to providing an information processing apparatus capable of displaying to a user a change in the effective field of view for each frame in a moving image.

According to an aspect of the present disclosure, an information processing apparatus includes a processor, and a memory storing a program which, when executed by the processor, causes the processor to, perform display control processing of displaying on a screen a timeline area corresponding to a playback time of a plurality of frame images included in a moving image content, perform blur correction processing on a first frame image included in the plurality of frame images based on an amount of subject blur in the first frame image caused by movement of an imaging apparatus for capturing the moving image content, and perform acquisition processing of acquiring a first field of view of the first frame image subjected to the blur correction processing, the first field of view being displayed during playback of the first frame image, wherein the display control processing performs control to distinguishably display a first section and a second section in the timeline area on the screen based on a field of view of each of the plurality of frame images subjected to the blur correction processing and displayed during playback of each frame image, the first section being a section of a frame image having the field of view that satisfies a predetermined condition, and the second section being a section of a frame image having the field of view that does not satisfy the predetermined condition.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an internal configuration of an information processing apparatus according to a first embodiment of the present disclosure.

FIG. 2A is a diagram illustrating an example of converting a dual-fisheye moving image into an equirectangular projection format for Virtual Reality 180 degrees (VR180) while blur correction is being applied according to the first embodiment.

FIG. 2B is a diagram illustrating an example of converting a dual-fisheye moving image into the equirectangular projection format for VR180 while blur correction is being applied according to the first embodiment.

FIG. 3 is a flowchart illustrating processing where the information processing apparatus according to the first embodiment of the present disclosure performs predetermined image processing on a dual-fisheye moving image while blur correction is being applied, and an effective field of view after the image processing is recorded.

FIG. 4 is a flowchart illustrating processing where a user of the information processing apparatus according to the first embodiment of the present disclosure specifies a condition regarding field of view, and a scene that does not satisfy the condition is clearly displayed on an editing screen.

FIG. 5 is an example screen of a user interface for editing a moving image content according to the first embodiment of the present disclosure.

FIG. 6 is a flowchart illustrating processing where a user of the information processing apparatus according to the first embodiment of the present disclosure specifies a condition regarding field of view, and a moving image is exported based on the specified condition.

### DESCRIPTION OF THE EMBODIMENTS

Some embodiments will now be described with reference to the accompanying drawings. Like reference numerals refer to like components, materials, and processing illustrated in the drawings, and redundant descriptions will be omitted as appropriate. In each drawing, components, materials, and processing are partly omitted. The following embodiments do not limit the present disclosure, and not all of the combinations of the features described in the embodiments are necessarily essential to the solution for the present disclosure. The configurations of the following embodiments may be suitably corrected or modified depending on the specifications and various conditions (operating conditions and operating environment) of the apparatus applicable to the present disclosure.

In the following embodiments, identical configurations are denoted by the same reference numerals and the following embodiments will be described accordingly.

### First Embodiment

### Internal Configuration of Information Processing Apparatus

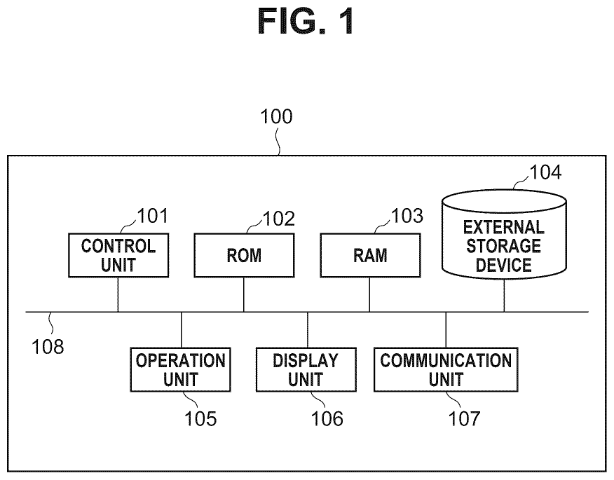

FIG. 1 is a block diagram illustrating an internal configuration of a personal computer (PC) 100 as an information processing apparatus according to the present disclosure. In the PC 100, a control unit 101, a read only memory (ROM) 102, a random access memory (RAM) 103, an external storage device 104, an operation unit 105, a display unit 106, and a communication unit 107 are connected to a system bus 108. An information processing system can be employed which includes each component of the PC 100 as an individual piece of hardware.

The control unit 101 is a central processing unit (CPU) for controlling the entire PC 100. The CPU executes programs, which will be described below, recorded in the ROM 102 to perform each piece of processing, which will be described below, of the following embodiments. Further, the control unit 101 controls the RAM 103, the external storage device 104, and the display unit 106 to perform display control. The entire information processing apparatus can be controlled by a plurality of pieces of hardware to each of which a piece of processing is assigned, instead of the control unit 101 controlling the entire information processing apparatus.

The ROM 102 is a non-volatile memory that can be electrically erased and recorded, such as an electrically erasable programmable read only memory (EEPROM). Constants and programs for operations of the control unit 101 are stored in the ROM 102. In this case, the programs refer to programs for performing processing illustrated in various flowcharts, which will be described below, according to the present embodiment.

The RAM 103 is a volatile memory where constants, variables, and programs read from the ROM 102 for operations of the control unit 101 are loaded. Examples of the RAM 103 include a volatile memory (dynamic random access memory (DRAM)) using semiconductor elements.

The external storage device 104 is a hard disk fixedly installed in the PC 100, a flash memory, a memory card attachable to and detachable from the PC 100, or another type of memory. According to the present embodiment, still image files and moving image files captured by an imaging apparatus, such as a camera, are stored in the external storage device 104.

The operation unit 105 is an input device for receiving user operations, including a text information input device, such as a keyboard, a pointing device, such as a mouse or a touch panel, buttons, dials, a joystick, a touch sensor, and a touch pad. The operation unit 105 transmits user operations to the control unit 101.

The display unit 106 displays images and graphical user interface (GUI) screens that include GUIs under the control of the control unit 101. The control unit 101 controls each unit of the PC 100 to generate display control signals according to a program and video signals for displaying images and GUIs on the display unit 106 to output the video signals to the display unit 106. The display unit 106 displays images based on the output video signals. The PC 100 itself can include an interface for outputting the video signals for causing the display unit 106 to display images and GUIs, while an external monitor, such as a television screen, can be the display unit 106.

The communication unit 107 is an interface for transmitting and receiving various kinds of data, such as files and commands, with an external device directly or via the Internet. The communication unit 107 may wirelessly communicate with the external device via a wireless communication method, such as Wireless Fidelity (Wi-Fi®) or Bluetooth®, or communicate with the external device via a wired connection.

### Processing for Converting Dual-Fisheye Moving Image into Moving Image in Equirectangular Projection Format for VR180

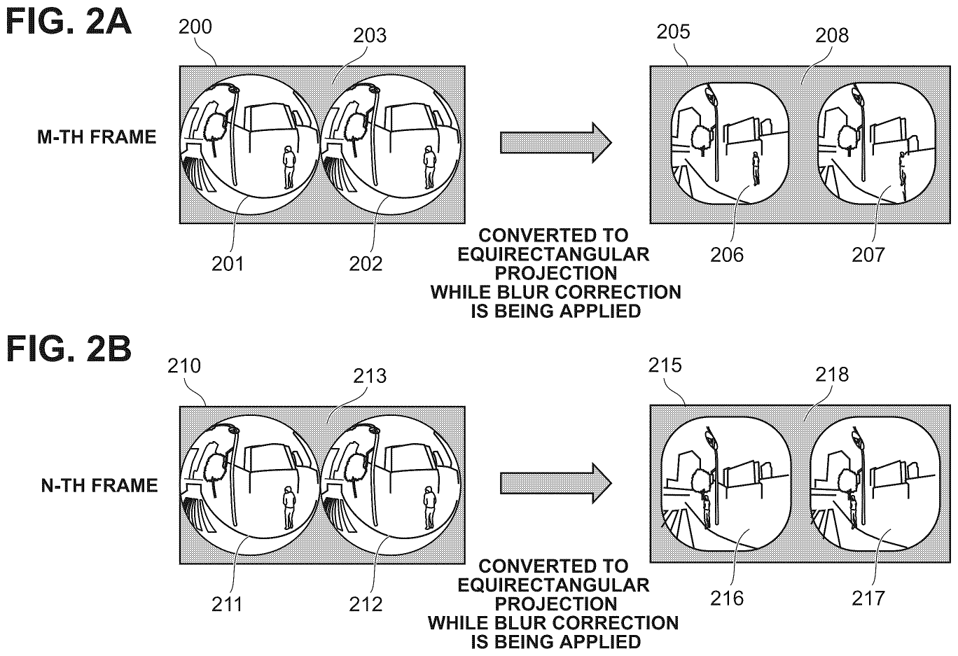

An example will now be described of converting a dual-fisheye moving image into an equirectangular projection format for Virtual Reality 180 degrees (VR180) while blur correction processing is being applied according to the first embodiment with reference to FIGS. 2A and 2B.

In FIG. 2A, an image 200 is a dual-fisheye image. The image 200 includes a circular image region 201 and a circular image region 202. The image 200 represents the image of the M-th frame in a moving image content. In each of the circular image regions 201 and 202, a subject image is formed via an optical system. The image 200 may be generated by forming two subject images on a single image sensor. The image 200 may be generated by combining images, each of which is generated by forming a subject image on a single image sensor via a single optical system. An invalid region 203 is different from the circular image regions 201 and 202 in the image 200. The invalid region 203 with no subject image formed via the optical system is filled with black pixels.

Here, it is assumed that, in the image 200, subject blur occurs due to movement of the imaging apparatus during capturing of the moving image content. In such a case where subject blur occurs, correction is performed for each frame of the moving image content based on the amount of subject blur caused by the movement of the imaging apparatus. Further, it is assumed that, in the M-th frame, the scene has a larger amount of subject blur than that in the N-th frame. Since the image 200 is a fisheye image having distortion, a conversion of the image 200 into the equirectangular projection format is performed.

An image 205 is generated by performing on the image 200 the above-described subject blur correction (the blur correction processing) and converting the image 200 into the equirectangular projection format. An image region 206 corresponds to the circular image region 201 in the image 200, and an image region 207 corresponds to the circular image region 202 in the image 200. The region in the image 205 different from the image regions 206 and 207 is an invalid region filled with black pixels.

In FIG. 2B, an image 210 is a dual-fisheye image. The image 210 includes a circular image region 211 and a circular image region 212. The image 210 represents the image of the N-th frame in a moving image content. In each of the circular image regions 211 and 212, a subject image is formed via an optical system. The image 210 may be formed by forming two subject images on a single image sensor. The image 210 may be generated by combining images, each of which is generated by forming a subject image on a single image sensor via a single optical system. An invalid region 213 is different from the circular image regions 211 and 212 in the image 210. The invalid region 213 with no subject image formed via the optical system is filled with black pixels.

Here, it is assumed that, in the image 210, subject blur occurs due to movement of the imaging apparatus during capturing of the moving image content. Further, it is assumed that, in the N-th frame, the scene has a smaller amount of subject blur than that in the M-th frame. Since the image 210 is a fisheye image having distortion, a conversion of the image 210 into the equirectangular projection format is performed.

An image 215 is generated by performing on the image 210 the above-described subject blur correction (the blur correction processing) and converting the image 210 into the equirectangular projection format. An image region 216 corresponds to the circular image region 211 in the image 210, and an image region 217 corresponds to the circular image region 212 in the image 210. The region in the image 215 different from the image regions 216 and 217 is an invalid region filled with black pixels.

The image 200 has a larger amount of blur than the image 210, and thus requires a larger amount of blur correction. Larger blur causes smaller image regions (the effective fields of view) after the blur correction.

Thus, the invalid region (the region of black pixels) becomes larger. Consequently, the image regions of the image 205 subjected to the blur correction have a narrower field of view than those of the image regions of the image 215 subjected to the blur correction.

For this reason, after the blur correction is applied to a VR180 moving image, the amount of blur varies depending on the scene, and thus the effective field of view also varies depending on the scene. It is necessary to display changes in the effective field of view for each frame of the moving image in a manner that facilitates the user's understanding because the video editor applies a mask or cuts a scene based on changes in the effective field of view.

According to the inventor's consideration, in order to avoid impairing the viewing experience, it is necessary to prevent invalid regions from appearing in a moving image on a head-mounted display viewed by the user. However, it is cumbersome for the video editor to manually identify and cut scenes with narrow effective fields of view.

### Processing Procedure for Performing Predetermined Image Processing on Dual-Fisheye Moving Image while Blur Correction Is Being Applied, and Recording Effective Field of View after Image Processing

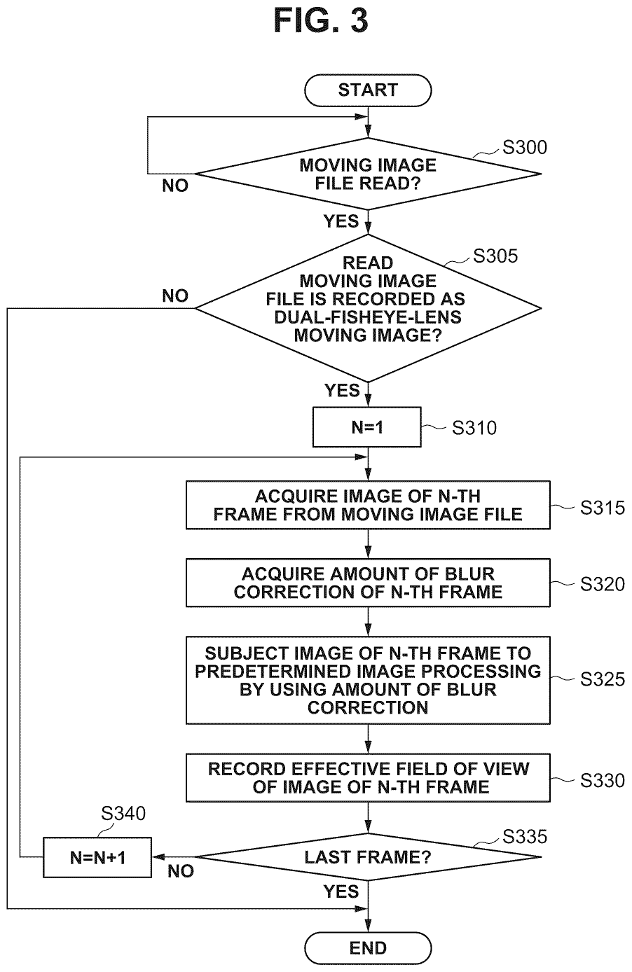

In FIG. 3, a flowchart will now be described for performing predetermined image processing on a circular dual-fisheye moving image while blur correction is being applied, and recording an effective field of view after the image processing. The control unit 101 executes this processing upon reception of a user operation for reading data about a moving image content from an external storage device or for receiving the data about the moving image content via the communication unit 107.

In step S300, the control unit 101 determines whether a moving image file is read. If the control unit 101 determines that a moving image file is read (YES in step S300), the processing proceeds to step S305. If the control unit 101 determines that a moving image file is not read (NO in step S300), the processing repeats step S300.

In step S305, the control unit 101 determines whether the moving image file read in step S300 is a moving image recorded using a dual-fisheye lens. If the control unit 101 determines that the moving image is recorded using a dual-fisheye lens (YES in step S305), the processing proceeds to step S310. If the control unit 101 determines that the moving image is not recorded using a dual-fisheye lens (NO in step S305), the processing of this flowchart ends. The control unit 101 may determine whether the moving image is recorded using a dual-fisheye lens based on whether meta data added to the moving image includes information indicating that the moving image is recorded using a dual-fisheye lens. Further, the control unit 101 may determine whether the moving image is a dual-fisheye moving image by analyzing a predetermined frame image of the moving image file. For example, in a case where a predetermined frame image of a moving image file is a dual-fisheye moving image having a predetermined parallax between the left and right, it is highly likely that two image regions as left and right image regions into which the dual-fisheye moving image is divided include the same captured subject, and it is considered that the two different image regions are correlated. In this manner, the control unit 101 may determine whether the moving image is recorded using a dual-fisheye lens by analyzing whether correlation is found based on pixels of the two different image regions.

In addition, the control unit 101 may determine whether the moving image is a dual-fisheye moving image by analyzing a predetermined frame image of the moving image file. Binarized image data is generated by applying a threshold which is approximately the luminance value of a black pixel to the luminance value of each pixel of the image data. Then, if the control unit 101 determines that the image represented by the binarized image data includes two different white circular regions, the control unit 101 determines that the moving image file includes two different circular fish-eye images. By using this method, if meta data is not added to the moving image file, a determination can be made as to whether the moving image is recorded using a dual-fisheye lens.

In step S310, the control unit 101 sets the frame count N to 1. The processing then proceeds to step S315.

In step S315, the control unit 101 acquires the image of the N-th frame from the moving image file read by the PC 100. The processing then proceeds to step S320.

In step S320, the control unit 101 determines the amount of blur correction for the image of the N-th frame read by the PC 100 in step S315. The processing then proceeds to step S325. The amount of blur correction is determined by using gyro information (inertial information) about the camera and lens meta data at the time of image capturing, changes in image features, and the like.

In step S325, the control unit 101 performs the predetermined image processing on the image of the N-th frame by using the amount of blur correction obtained by the PC 100 in step S320. The processing then proceeds to step S330. As the predetermined image processing, the control unit 101 performs, for example, geometric transformation processing that converts the image of the N-th frame into an image with reduced distortion in the moving image content. Examples of geometric transformation processing include a technique of converting a dual-fisheye moving image into the equirectangular projection format while blur correction is being applied to the moving image (equirectangular projection conversion processing) as illustrated in FIGS. 2A and 2B.

Other examples include a technique for converting a dual-fisheye moving image into a perspective projection format (perspective projection conversion processing) instead of the equirectangular projection format.

In step S330, the control unit 101 finds an effective field of view for the image subjected to the predetermined image processing by the PC 100 in step S325 to record the effective field of view. The processing then proceeds to step S335.

In step S335, the control unit 101 determines whether the N-th frame currently being processed is the last frame. If the control unit 101 determines that the N-th frame is the last frame of the moving image file (YES in step S335), the processing of this flowchart ends. If the control unit 101 determines that the N-th frame is not the last frame of the moving image file (NO in step S335), the processing proceeds to step S340.

In step S340, the control unit 101 increments the frame count N by one. The processing then returns to step S315.

### Processing for User Specifying Field of View Condition and Displaying Scene Not Satisfying Condition on Editing Screen

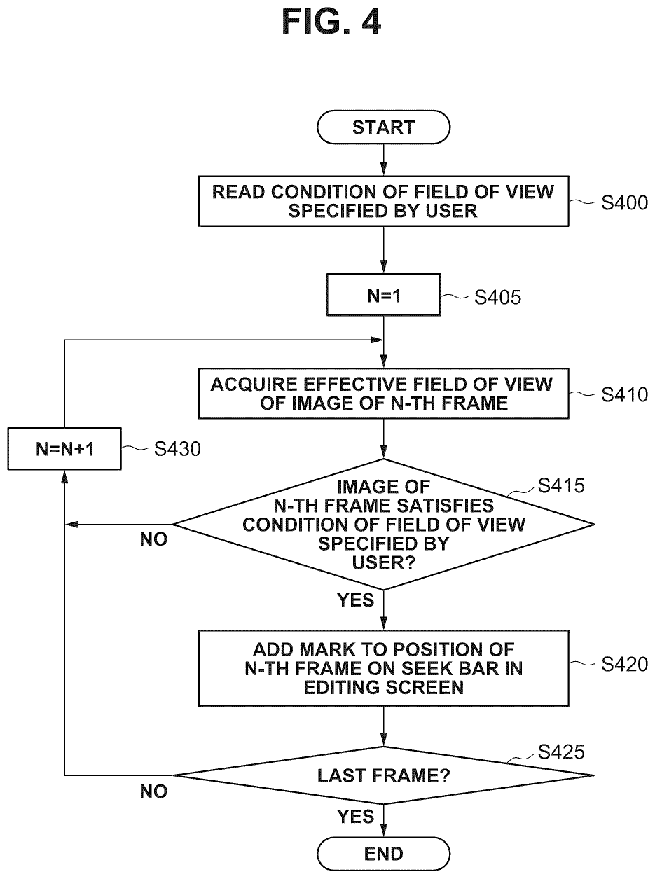

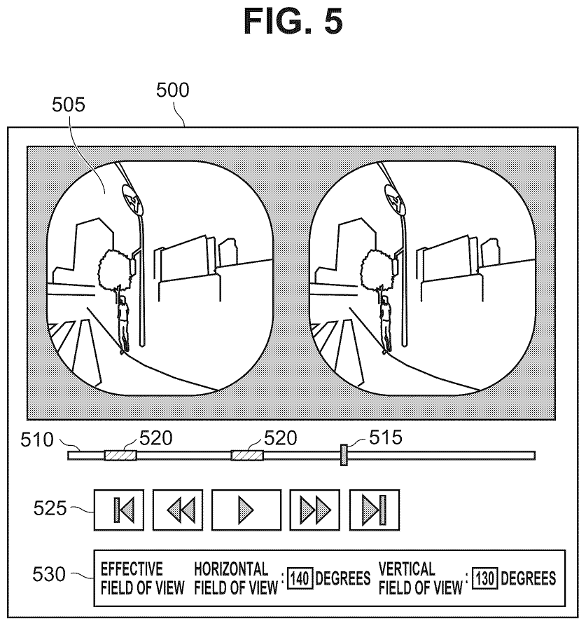

Processing will now be described for the user specifying a condition regarding field of view and displaying a scene that does not satisfy the condition on an editing screen with reference to FIGS. 4 and 5. FIG. 4 is a flowchart illustrating processing for the user specifying a condition regarding field of view and displaying a scene that does not satisfy the condition on the editing screen. The control unit 101 executes this processing upon receiving a user operation for reading from an external storage device data about a moving image content with effective fields of view set and upon setting a condition regarding effective field of view of the moving image content by the user. Alternatively, the control unit 101 executes this processing upon receiving a user operation for receiving via the communication unit 107 data about a moving image content with effective fields of view set and upon setting a condition regarding effective field of view of the moving image content by the user.

In step S400, the control unit 101 reads a condition regarding field of view specified by the user. The processing then proceeds to step S405.

In step S405, the control unit 101 sets the frame count N to 1. The processing then proceeds to step S410.

In step S410, the control unit 101 acquires the effective field of view of the image of the N-th frame recorded in step S330. The processing proceeds to step S415.

In step S415, the control unit 101 determines whether the effective field of view of the image of the N-th frame acquired in step S410 satisfies the condition regarding field of view specified in step S400. If the control unit 101 determines that the effective field of view of the image of the N-th frame acquired in step S410 satisfies the condition regarding field of view specified in step S400 (YES in step S415), the processing proceeds to step S420. If the control unit 101 determines that the effective field of view of the image of the N-th frame acquired in step S410 does not satisfy the condition regarding field of view specified in step S400 (NO in step S415), the processing proceeds to step S430.

In step S420, the control unit 101 adds a mark to the position of the N-th frame on a seek bar in the editing screen. The processing then proceeds to step S425. Examples of the condition regarding field of view include “whether the effective field of view does not satisfy at least one of set fields of view, i.e., a horizontal field of view and a vertical field of view”. In other words, if the field of view is narrower than the set effective field of view, a mark is added in step S420.

In step S425, the control unit 101 determines whether the N-th frame currently being processed is the last frame. If the control unit 101 determines that the N-th frame currently being processed is the last frame (YES in step S425), the processing of this flowchart ends. If the control unit 101 determines that the N-th frame currently being processed is not the last frame (NO in step S425), the processing proceeds to step S430.

In step S430, the control unit 101 increments the frame count N by one. The processing then returns to step S410.

In this manner, following the procedure illustrated in FIG. 4 allows the user to visually identify playback sections that satisfy the condition set by the user out of the playback sections of the moving image, reducing the effort required for the user to search for scenes that do not satisfy the condition while playback sections of the moving image that do not satisfy effective field of view are being played.

FIG. 5 illustrates an example of a user interface screen implemented by the flowchart in FIG. 4.

It is assumed that the display unit 106 displays a screen 500. The user sets an effective field of view and edits a moving image content while checking the screen 500. The screen 500 includes a moving image display region 505, a timeline area 510, a playback position 515, marks 520 each indicating a section satisfying a user-set condition, playback buttons 525, and an effective field of view setting region 530.

The timeline area 510 corresponds to the playback time of a read moving image content, and represents temporal change in the VR content (change according to the elapsed playback time) in at least a part of the playback period.

The playback position 515 indicates a position in the timeline area 510 corresponding to the playback time of the moving image content currently being played, and the frame image of the moving image content corresponding to the position is displayed in the moving image display region 505.

The marks 520 each indicate a section satisfying a condition set by the user in the effective field of view setting region 530. In this case, the condition regarding field of view is that a horizontal field of view of 140 degrees and a vertical field of view of 130 degrees are set as threshold values.

The playback and rewind buttons 525 include a button for starting and stopping playback of a moving image content, fast-forward and rewind buttons, and skip buttons. The screen 500 may include another user interface for checking frame images of a moving image content.

Such processing makes it possible to display to the user, in a distinguishable manner, sections that satisfy the condition regarding field of view specified by the user, such as the marks 520 each indicating a section satisfying the user-set condition, and sections that do not satisfy the condition.

In other words, according to the above-described example, a section can be displayed that satisfies the condition set by the user, i.e., a section where the invalid region will appear in a moving image on a head-mounted display or the like viewed by the user due to a narrower effective field of view than the field of view set by the user caused by the blur correction. The moving image can be trimmed to delete sections where the effective field of view is narrower than the field of view set by the user. Furthermore, the effective field of view of the sections where the effective field of view is narrower than the field of view set by the user can be widened so that the invalid region will not appear.

When the condition regarding field of view is changed, i.e., when a numerical value in the effective field of view setting region 530 is changed, the control unit 101 executes the processing illustrated in FIG. 4 again based on the changed condition regarding field of view.

### Second Embodiment

### Processing Procedure for User Specifying Condition of Field of View and Exporting Moving Image Based on Specified Condition

In the first embodiment described above, the example has been described where the control unit 101 displays sections that satisfy a condition regarding field of view specified by the user, and sections that do not satisfy the condition regarding field of view specified by the user. In a second embodiment, an example will be described where sections that satisfy a condition regarding field of view specified by the user, and sections that do not satisfy the condition regarding field of view specified by the user are further stored separately.

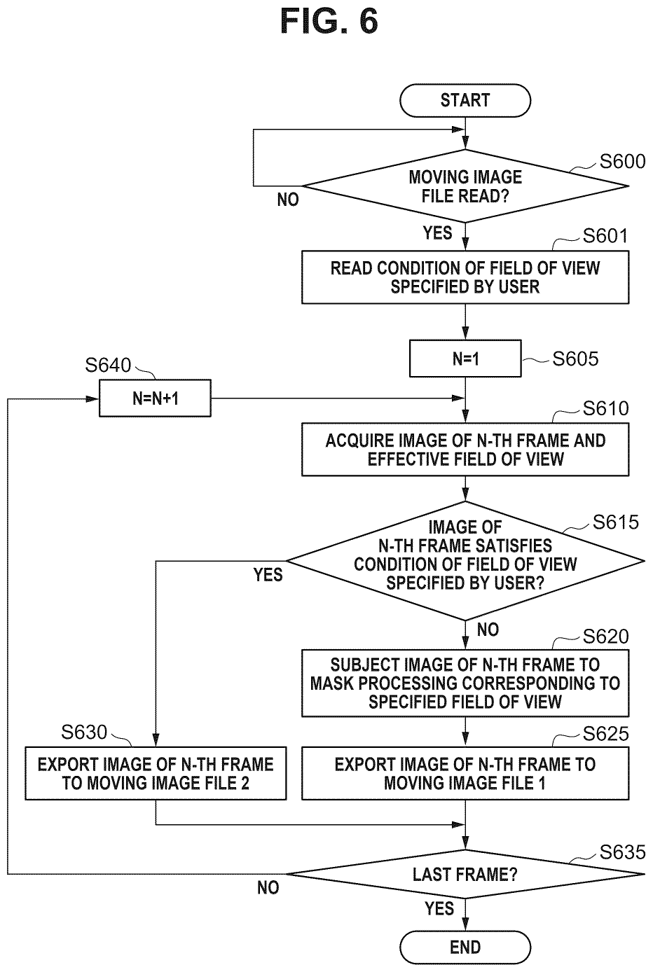

Processing will now be described for the user specifying a condition regarding field of view and exporting a moving image based on the specified condition with reference to FIG. 6. The control unit 101 executes this processing upon receiving a user operation for reading from an external storage device data about a moving image content with effective fields of view set and upon setting a condition regarding effective field of view of the moving image content by the user. Alternatively, the control unit 101 executes this processing upon receiving a user operation for receiving via the communication unit 107 data about a moving image content with effective fields of view set and upon setting a condition regarding effective field of view of a moving image content by the user.

In step S600, the control unit 101 determines whether a moving image file is read. If the control unit 101 determines that the moving image file is read (YES in step S600), the processing proceeds to step S601. If the control unit 101 determines that the moving image file is not read (NO in step S600), the processing repeats step S600.

In step S601, the control unit 101 causes the PC 100 to read the condition regarding field of view specified by the user.

In step S605, the control unit 101 sets the frame count N to 1. The processing then proceeds to step S610.

In step S610, the control unit 101 acquires the image of the N-th frame from the read moving image file, and the effective field of view of the image of the N-th frame recorded in step S330. The processing then proceeds to step S615.

In step S615, the control unit 101 determines whether the effective field of view of the image of the N-th frame acquired in step S610 satisfies the condition regarding field of view specified in step S601.

If the control unit 101 determines that the effective field of view of the image of the N-th frame acquired in step S610 satisfies the condition regarding field of view specified in step S601 (YES in step S615), the processing proceeds to step S630.

If the control unit 101 determines that the effective field of view of the image of the N-th frame acquired in step S610 does not satisfy the condition regarding field of view specified in step S601 (NO in step S615), the processing proceeds to step S620. A case will be considered where, for example, a horizontal field of view of 140 degrees and a vertical field of view of 130 degrees are set as threshold values, and the condition regarding field of view is that the effective field of view are smaller than the threshold values. In this case, a frame image with a horizontal field of view of 140 degrees or more and a vertical field of view of 130 degrees or more is determined to be a frame image that does not satisfy the condition regarding fields of view. Further, a frame image with a horizontal field of view of less than 140 degrees or a vertical field of view of less than 130 degrees is determined to be a frame image that satisfies the condition regarding field of view.

In step S620, the control unit 101 performs the mask processing based on specified fields of view on the image of the N-th frame read by the PC 100. The processing then proceeds to step S625. For example, if a horizontal field of view of 140 degrees and a vertical field of view of 130 degrees are set as the threshold values as the condition regarding field of view, a frame image that satisfies the predetermined condition has small blur and wide effective fields of view. In this case, processing is performed of blacking out the portions of the moving image with a horizontal field of view of 140 degrees or more or a vertical field of view of 130 degrees or more in order to make the effective fields of view of the moving image file to be exported uniform for each frame image.

In step S625, the control unit 101 causes the PC 100 to export the image of the N-th frame to a moving image file 1. The processing then proceeds to step S635. Specifically, the moving image file 1 with the effective fields of view set under the predetermined condition regarding field of view is generated from a frame image group that does not satisfy the predetermined condition regarding field of view.

In step S630, the control unit 101 exports the image of the N-th frame to a moving image file 2. The processing then proceeds to step S635. Specifically, the moving image file 2 that satisfies the predetermined condition regarding field of view is generated.

In this manner, by the processing in steps S625 and S630, the control unit 101 exports scenes that satisfy the condition regarding field of view specified by the user and scenes that do not satisfy the condition are exported to separate moving image files, respectively. An export destination can be the RAM 103, the external storage device 104, or another device connected via the communication unit 107.

In step S635, the control unit 101 determines whether the N-th frame currently being processed is the last frame. If the control unit 101 determines that the N-th frame currently being processed is the last frame (YES in step S635), the processing of this flowchart ends. If the control unit 101 determines that the N-th frame currently being processed is not the last frame (NO in step S635), the processing proceeds to step S640.

In step S640, the control unit 101 increments the frame count N by one. The processing then returns to step S610.

In this manner, following the above-described processing makes it possible to generate a moving image content by extracting only time sections having a user-set effective field of view from sections with small blur and a small amount of blur correction applied out of the moving image content. While the moving image file 1 includes sections having fields of view equal to or larger than the user-set effective fields of view, this processing enables the generation of the moving image file 1 uniform in user-set effective fields of view.

The control unit 101 may export one of the moving image files 1 and 2, and not export the other.

The example has been described where the moving image file 1 is generated as a moving image file having user-set effective fields of view. However, a moving image file including frame images having user-set effective fields of view or larger can be generated without executing step S620.

### Modifications

The example of the user interface screen illustrated in FIG. 5 may further include a button for switching between display and non-display of either sections satisfying a user-set condition or sections not satisfying the user-set condition in the timeline area 510. Further, for example, if an instruction is issued to hide sections satisfying a user-set condition in the timeline area 510, a moving image content with the hidden sections (also, referred to as sections in a non-display state) cropped may be generated to allow the user to view the moving image content. This makes it possible to generate a moving image content including frame images of sections that do not satisfy a user-set condition without checking each frame image.

The example of the user interface screen illustrated in FIG. 5 may further include a button for exporting a moving image file of sections currently displayed in the timeline area 510. For example, if an instruction is issued to export a moving image file in a state where sections satisfying a user-set condition are hidden as described above, a moving image file with the hidden sections cropped may be exported.

### Other Embodiments

The present disclosure is also implemented by performing the following processing. Specifically, software (a program) for implementing the functions of the above-described embodiments is supplied to a system or an apparatus via a network or various types of storage media, and a computer (or a control unit, micro processing unit (MPU), or the like) of the system or the apparatus reads and executes the program code. In this case, the program and the storage medium storing the program are included in the present disclosure.

While the present disclosure has specifically been described in detail above based on the embodiments, the present disclosure is not limited to these specific embodiments. Various forms not departing from the spirit and scope of the present disclosure are also included in the present disclosure. Parts of the above-described embodiments may be suitably combined.

The present disclosure makes it possible to display a change in effective field of view for each frame in a moving image to a user.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-202202, filed Nov. 20, 2024, which is hereby incorporated by reference herein in its entirety.

What is claimed is:

1. An information processing apparatus comprising:
a processor; and
a memory storing a program which, when executed by the processor, causes the processor to:
perform display control processing of displaying on a screen a timeline area corresponding to a playback time of a plurality of frame images included in a moving image content;
perform blur correction processing on a first frame image included in the plurality of frame images based on an amount of subject blur in the first frame image caused by movement of an imaging apparatus for capturing the moving image content; and
perform acquisition processing of acquiring a first field of view of the first frame image subjected to the blur correction processing, the first field of view being displayed during playback of the first frame image,
wherein the display control processing performs control to distinguishably display a first section and a second section in the timeline area on the screen based on a field of view of each of the plurality of frame images subjected to the blur correction processing and displayed during playback of each frame image, the first section being a section of a frame image having the field of view that satisfies a predetermined condition, and the second section being a section of a frame image having the field of view that does not satisfy the predetermined condition.

2. The information processing apparatus according to claim 1, wherein the program, when executed by the processor, further causes the processor to perform, in a case where the field of view subjected to the blur correction processing is narrower than a predetermined field of view, determination processing of determining that a section of a frame image satisfies the predetermined condition.

3. The information processing apparatus according to claim 1, wherein the first section is a section of a frame image having a field of view smaller than a predetermined field of view, the field of view being determined by the blur correction processing and displayed during the playback.

4. The information processing apparatus according to claim 3,
wherein the program, when executed by the processor, further causes the processor to perform second acquisition processing of acquiring an instruction to set the predetermined field of view, and
wherein, in a case where the predetermined field of view is changed, the first section and the second section are distinguishably displayed based on the changed predetermined field of view.

5. The information processing apparatus according to claim 1, wherein the display control processing displays a frame image currently being played on the screen, and a position indicating a playback time corresponding to the frame image in the timeline area.

6. The information processing apparatus according to claim 1, wherein the program, when executed by the processor, further causes the processor to perform determination processing of determining the amount of subject blur based on inertial information about the imaging apparatus in capturing the moving image content.

7. The information processing apparatus according to claim 1, wherein the program, when executed by the processor, further causes the processor to perform determination processing of determining the amount of subject blur based on metadata added to the moving image content.

8. The information processing apparatus according to claim 1, wherein the program, when executed by the processor, further causes the processor to perform determination processing of determining the amount of subject blur based on an image feature included in the moving image content.

9. The information processing apparatus according to claim 1, wherein the program, when executed by the processor, further causes the processor to perform generation processing of generating a second moving image content including the second section with the first section cropped.

10. The information processing apparatus according to claim 9, wherein the generation processing generates the second moving image content, and a third moving image content including the first section with the second section cropped.

11. The information processing apparatus according to claim 1, wherein the program, when executed by the processor, further causes the processor to perform generation processing of generating a second moving image content by cropping a section having the field of view smaller than a predetermined field of view, and setting a frame image of a section having the field of view equal to or larger than the predetermined field of view as a frame image having the predetermined field of view, based on the field of view of each of the plurality of frame images subjected to the blur correction processing and displayed during playback of each frame image.

12. The information processing apparatus according to claim 1,
wherein the program, when executed by the processor, further causes the processor to perform second acquisition processing of acquiring an instruction to switch between display and non-display of the first section or the second section in the timeline area, and
wherein the display control processing controls display of the timeline based on the instruction.

13. The information processing apparatus according to claim 12,
wherein the second acquisition processing acquires an instruction to generate a moving image content in a state where the first section or the second section of the timeline area is in a non-display state, and
wherein, in response to acquisition of the instruction to generate the moving image content in the second acquisition processing, a second moving image content with the section in the non-display state cropped is generated.

14. The information processing apparatus according to claim 1,
wherein the moving image content is a moving image of an image having distortion, and
wherein the image processing further executes geometric conversion processing of converting the moving image content into an image with the distortion reduced.

15. The information processing apparatus according to claim 14,
wherein the moving image content is a circular fish-eye image, and
wherein the geometric conversion processing is perspective projection conversion processing or equirectangular projection conversion processing.

16. An information processing method comprising:
displaying on a screen a timeline area corresponding to a playback time of a plurality of frame images included in a moving image content;
performing blur correction processing on a first frame image included in the plurality of frame images based on an amount of subject blur in the first frame image caused by movement of an imaging apparatus for capturing the moving image content; and
acquiring a first field of view of the first frame image subjected to the blur correction processing, the first field of view being displayed during playback of the first frame image,
wherein control is performed to distinguishably display a first section and a second section in the timeline area on the screen based on a field of view of each of the plurality of frame images subjected to the blur correction processing and displayed during playback of each frame image, the first section being a section of a frame image having the field of view that satisfies a predetermined condition, and the second section being a section of a frame image having the field of view that does not satisfy the predetermined condition.

17. A non-transitory computer readable medium that stores a program, wherein the program causes a computer to execute the information processing method according to claim 16.

18. An information processing system comprising:
an imaging apparatus configured to generate a moving image content;
a display control apparatus configured to display on a screen a timeline area corresponding to a playback time of a plurality of frame images included in the moving image content;
an image processing apparatus configured to perform blur correction processing on a first frame image included in the plurality of frame images based on an amount of subject blur in the first frame image caused by movement of the imaging apparatus; and
an acquisition apparatus configured to acquire a first field of view of the first frame image subjected to the blur correction processing, the first field of view being displayed during playback of the first frame image,
wherein the display control apparatus performs control to distinguishably display a first section and a second section in the timeline area on the screen based on a field of view of each of the plurality of frame images subjected to the blur correction processing and displayed during playback of each frame image, the first section being a section of a frame image having the field of view that satisfies a predetermined condition, and the second section being a section of a frame image having the field of view that does not satisfy the predetermined condition.
